(19) United States
(12) Patent Application Publication
(10) Pub. No.: US 2006/0082664 A1
(43) Pub. Date: Apr. 20, 2006

(54) Moving image processing unit, moving image processing method, and moving image processing program

(75) Inventors: Naofumi Yoshida, Kanagawa (JP); Jun Miyazaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/111,816

(22) Filed: Apr. 22, 2005

(30) Foreign Application Priority Data
Oct. 20, 2004 (JP) 2004-305305

(51) Int. Cl. H04N 5/76

(52) U.S. Cl. 348/239; 348/231.2; 348/231.3

(57) ABSTRACT

A moving image processing unit has a sensor management unit and an attachment unit. The sensor management unit manages sensors that detect at least one of a person, an object, a movement of the person or the object, and sound information as sensor information, while a moving image is being captured. The attachment unit attaches metadata to the moving image, after checking a combination of the sensor information based on the sensor information outputted from the sensor management unit.

### BACKGROUND OF THE INVENTION

1. Field of the Invention

This invention relates to a moving image processing unit, a moving image processing method, and a moving image processing program.

2. Description of the Related Art

Metadata describes data or information about target data. Metadata is created for helping search vast amounts of data for the target data. With respect to search and edit a moving image with the use of the metadata, related arts have been proposed as follows.

Japanese Patent Publication of Application No. 2004-172671 describes a moving picture processing apparatus. The moving picture processing apparatus automatically generates an output moving picture in response to a moving picture feature quantity and how to use the moving picture by utilizing attached metadata to segment a received moving picture at a proper region by each frame.

Japanese Patent Publication of Application No. 2003-259268 describes a moving picture management device. The moving picture management device can easily correct the metadata attached to the moving picture and utilize the moving picture even after the moving picture is edited.

Japanese Patent Publication of Application No. 2001-268479 describes a moving image retrieval device. The moving image retrieval device extracts an object area from an input image, and further extracts a changing shape feature including a change in a continuous frame shape in the object area so as to store in a metadata database in advance. The metadata having a designated shape feature for retrieval is compared with the metadata stored in the metadata database in advance so as to display the images of similarity.

It is to be noted that it is difficult to attach an annotation to the moving image or extract the metadata of the moving image. Specifically, it is difficult to record someone or something in the moving image and attach the metadata to the moving image concurrently. This arises a problem in that the aforementioned moving image cannot be retrieved with the metadata. The techniques disclosed in the above-mentioned related arts are not capable of automatically attaching the metadata to the moving image.

### SUMMARY OF THE INVENTION

The present invention has been made in view of the above circumstances and provides a moving image processing unit and moving image processing method and program that can enable to search a moving image.

According to an aspect of the present invention, the invention provides a moving image processing unit including a sensor management unit that manages sensors that detect at least one of a person, an object, or a movement of the person or the object as sensor information, while a moving image is being captured; and an attachment unit that attaches a metadata to the moving image, after checking a combination of the sensor information based on the sensor information output from the sensor management unit.

According to another aspect of the present invention, the invention provides a moving image processing method including detecting with a sensor at least one of a person, an object, or a movement of the person or the object while a moving image is being captured, as sensor information, and attaching a metadata to the moving image, after checking a combination of the sensor information based on the sensor information.

According to another aspect of the present invention, the invention provides a storage medium readable by a computer to execute a process of outputting images from an output unit on a computer, the function of the storage medium including acquiring sensor information of a sensor that detects at least one of a person, an object, or a movement of the person or the object while a moving image is being captured, and attaching a metadata to the moving image, after checking a combination of the sensor information based on the sensor information.

In accordance with the present invention, the combination of the sensor information is checked based on the sensor information output from the sensor that detects the person, the object, or the movement of the person or the object. It is thus possible to attach the metadata to the moving image automatically. Also, it is possible to attach the metadata to the moving image manually at a predetermined timing by a user's instruction. This makes it possible to search the moving image having the common feature as that of the person, the object, or the movement of the person or the object. The sensor includes a button for making remarks, microphone, position information sensor, handwritten input sensor, and the like.

### BRIEF DESCRIPTION OF THE DRAWINGS

Embodiments of the present invention will be described in detail based on the following figures, wherein:

FIG. 1 is a view showing a configuration of a moving image processing unit in accordance with a first embodiment of the present invention;

FIG. 2 shows a data structure of a sensor database;

FIG. 3 shows a dynamic loose coupling of sensor devices;

FIG. 4 is a flowchart showing a procedure of attaching a metadata of a sensor combination determination unit;

FIG. 5 is a view showing a configuration of a moving image processing unit in accordance with a second embodiment of the present invention; and

FIG. 6 is a flowchart showing another procedure of attaching the metadata of the sensor combination determination unit.

### DESCRIPTION OF THE EMBODIMENTS

A description will now be given, with reference to the accompanying drawings, of embodiments of the present invention.

### First Embodiment

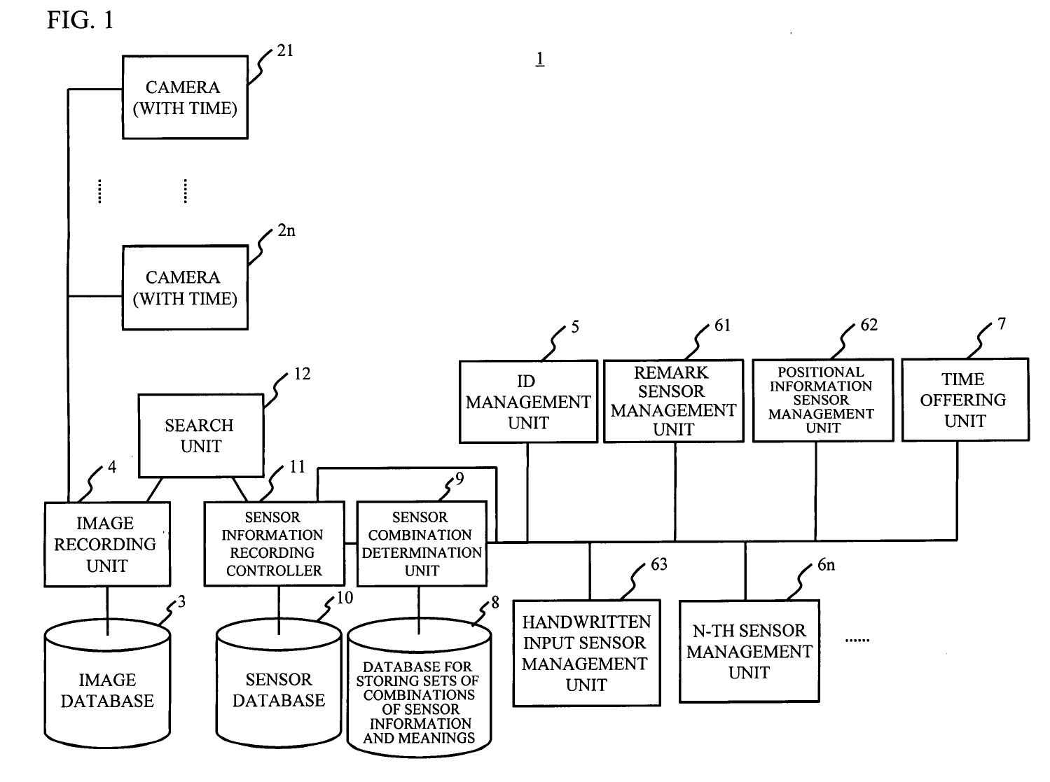

FIG. 1 is a view showing a configuration of a moving image processing unit in accordance with a first embodiment of the present invention. Referring to FIG. 1, a moving image processing unit 1 includes at least one or more cameras 2n, an image database 3, an image recording unit 4, an ID management unit 5, a remark sensor management unit 61, a positional information sensor management unit 62, a handwritten input sensor management unit 63, an nth sensor management unit 6n, a time offering unit 7, a database 8 for storing sets of the combinations of the sensor information and meanings thereof, a sensor combination determination unit 9, a sensor database 10, a sensor information recording controller 11, and a search unit 12.

The moving image processing unit 1 acquires one or more IDs of a person, an object, or a movement of the person or the object to be captured in the moving image, positional information, and a timestamp, as a combination of the sensor information. The moving image processing unit 1 stores a metadata, in which a meaning of the aforementioned combination of different kinds of the sensor information is reflected. One meaning is given to every combination of the different kinds of the sensor information in advance. One meaning and one combination forms one set. The moving image processing unit realizes a moving image database. The moving image can be searched with an extracted metadata, the moving image having a common feature with that of the person, the object, or the movement of the person or the object in the extracted metadata.

The camera 2n is set up in a meeting room, for example, and outputs a shot image and time information when the image is shot, to the image recording unit 4. The image database 3 is used for storing the shot image and the time information when the image is shot. The image recording unit 4 stores the moving images that have been captured by the cameras 21 through 2n together with the time information, in the image database 3. The ID management unit 5 manages an ID of the person, the object, or a movement of the person or the object to be taken as the moving image in the meeting room. Here, the object includes a projector or a white board or the like. The movement includes a handwriting input or the like. The ID in the ID management unit 5 is used for identifying a remark as whose remark. It is important who makes what movement particularly in a meeting. The ID management unit 5 identifies the ID. This makes it possible to identify whose movement of the moving image is and when the metadata is attached to the moving image. The metadata of high abstractiveness and high availability is thus created. The sensor combination determination unit 9 is capable of recognizing a target to be captured with the ID of the ID management unit 5.

The remark sensor management unit 61 controls and manages a remark sensor such as a button for making remarks, a microphone, or the like. The remark sensor detects that the button for making remarks has been pushed or that a switch of the microphone has been turned on and the remark has been made. The positional information sensor management unit 62 controls and manages a positional information sensor that detects an ID card held by the person or the ID given to the object installed in the meeting room. The handwritten input sensor management unit 63 controls and manages a handwritten input sensor for detecting that something has been drawn on the white board with a certain pen, for example.

The nth sensor management unit 6n is a sensor management unit excluding the remark sensor management unit 61, the positional information sensor management unit 62, and the handwritten input sensor management unit 63. The nth sensor management unit 6n controls and manages a sensor for sensing the person, the object, and the movement of the person or the object, while the moving image is being taken. In this embodiment, the sensor management units 61 through 6n communicate with the sensor combination determination unit 9 in an expression of URL format. This can realize a dynamic loose coupling between different sensor devices in the URL format only. The sensor information is output from the remark sensor management unit 61, the positional information sensor management unit 62, the handwritten input sensor management unit 63, and the nth sensor management unit 6n.

The time offering unit 7 offers a detection time to each of the sensor management units 61 through 6n, if the sensor management unit does not have the time information. The sensor management units 61 through 6n receive the time information from the time offering unit 7, combines the sensor information with the time information, and outputs the sensor information and the time information. The time offering unit 7 is a time management unit.

The meaning of the combination of the different pieces of the sensor information is reflected in the metadata in advance, and the metadata is stored in the database 8 for storing sets of the combinations of the sensor information and meanings thereof. The sensor combination determination unit 9 acquires as the sensor information, a set of the person or the object to be captured in the moving image, the ID of the movement made by the person or the object, the sensor information from the sensor management units 61 through 6n, and a time stamp. The sensor combination determination unit 9 refers to the database 8 for storing sets of the combinations of the sensor information and meanings thereof, and checks the combination of the sensor information to attach the metadata to the moving image. The sensor database 10 includes the sensor information, the metadata, and parameters. The sensor information includes the sensor ID, the time information, or the like. The sensor information recording controller 11 associates the sensor information, the time information and the metadata obtained from the sensor combination determination unit 9 to record in the sensor database 10.

The database 8 for storing sets of the combinations of the sensor information and meanings thereof in a memory. The sensor combination determination unit 9 is an attachment unit. The sensor information recording controller 11 is a recording controller.

The search unit 12 searches the image database 3 for the moving image, based on an inputted search condition and the metadata stored in the sensor database 10. The search unit 12 concurrently displays the moving image and the metadata thereof along a time axis as a user interface UI, and searches a portion of the moving image to be replayed. The search unit 12 starts searching when a searcher inputs a keyword (the search condition). The search unit 12 identifies the person, the object, or the movement of the person or the object that is desired by a user, in the sensor database 10, acquires the moving image having the time same as or close to the time information, and provides the moving image to the user.

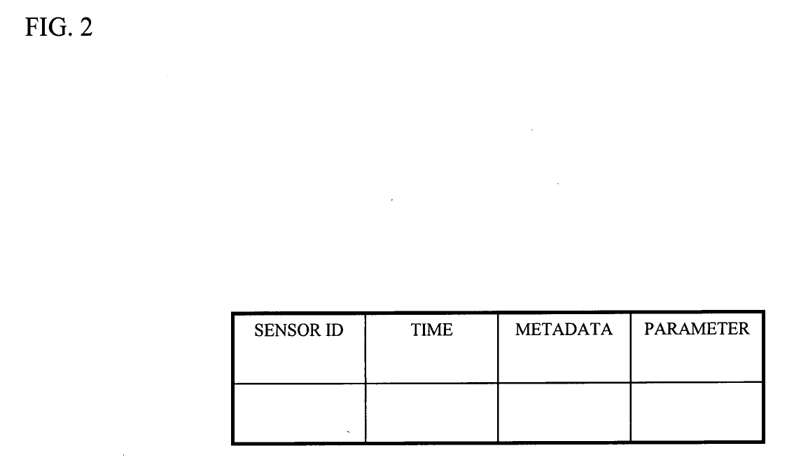

A description will now be given of a data structure of the sensor database 10. FIG. 2 shows the data structure of the sensor database 10. Referring to FIG. 2, the sensor database 10 includes the sensor ID, the time, the metadata, and the parameter. The sensor information includes the sensor ID, the time, and the parameter. When the metadata are recorded, a set of the time and the metadata are recorded as one element on a line of the aforementioned data structure. When the sensor information is recorded directly, the sensor ID, the time and the parameter are recorded. When the multiple parameters are recorded, the multiple parameters are divided and written into multiple lines. The parameter denotes an output data specific to the sensor. The output data does not include the sensor ID or the time. For example, the parameters of a position sensor are x-axis, y-axis, and z-axis. The parameter of the remark sensor is whether or not the remark has been made for example. The parameters of the handwritten input sensor are collections of point data, which form a handwritten character or the like.

A description will be given of a data structure of the database 8 for storing sets of the combinations of the sensor information and meanings thereof. A sensor combination condition and the corresponding metadata are described as a collection of the following expression. ( ) defines a priority, and may be used in the left part of the expression as in the normal logical expression.
(sensor ID₁, parameter condition₁) and/or (sensor ID₂, parameter condition₂) and/or . . . =metadata.

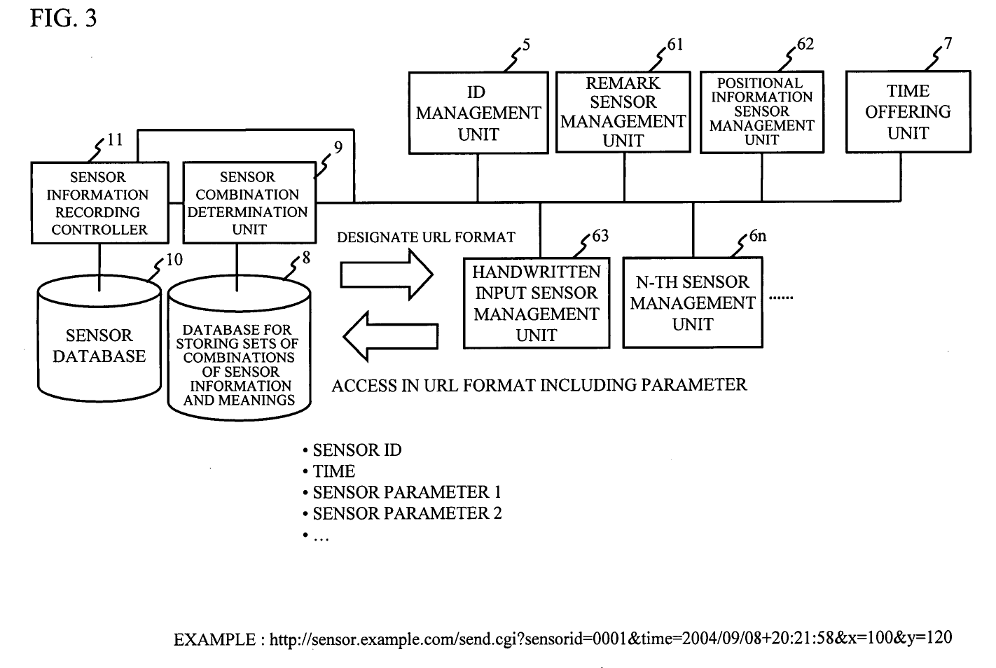

FIG. 3 shows the dynamic loose coupling of the sensor devices. As shown in FIG. 3, the expression in the URL format is determined as a communication format, in connection with the sensor combination determination unit 9, the ID management unit 5, and the sensor management units 61 through 6n, and the time offering unit 7. The ID management unit 5, and the sensor management units 61 through 6n, and the time offering unit 7 send the sensor ID, the time, and a parameter 1 and a parameter 2, to the sensor combination determination unit 9 and the sensor information recording controller 11, in accordance with the communication format. Generally, there arises a problem on both sides when unifying the system interface and the system is largely changed. Moreover, the sensors have compact shapes and it is difficult to introduce a complicated communication mechanism.

For example, the sensor combination determination unit 9 is realized as a WWW server named sensor.example.com. If one sensor is connected through the sensor management units 61 through 6n, the sensor management units 61 through 6n respectively access the following URL shown as an example, and send the data acquired by the sensor to the sensor combination determination unit 9. The sensor management units 61 through 6nhave to know a transmission format only, and do not have to know other details.

http://sensor.example.com/send.cgi?sensorid=0001&tim e=2004/09/08+20:21:58&x=100&y=120

In the above-mentioned manner, the sensor devices can be connected, changed, and disconnected easily, without changing the structure of the sensor devices dynamically.

A description will now be given of an example of the metadata of the sensor combination determination unit 9. The sensor combination determination unit 9 refers to the database 8 for storing sets of the combinations of the sensor information and meanings thereof, reflects in the metadata, the meaning of the combination of the different pieces of the sensor information given in advance, and attaches the metadata to the moving image. As one example of the meaning of the combination of the different kinds of the sensor information given in advance, if someone who is close to the white board creates a drawing with a three-dimensional pen, which means a strong assertion. Examples of the meaning of the combination of the different kinds of the sensor information given in advance are as follows.

(1) Someone who is close to the white board creates a drawing with a three-dimensional pen. The metadata of “strong assertion” is attached.

(2) The button for making remarks is pushed or the switch of the microphone given to each participant of the meeting is turned on and a participant says something. The metadata of “remark” is attached.

(3) Show of hands is detected with the use of image recognition. If a majority of the participants show hands at the same time, the metadata of “decision” or “approval” is attached.

(4) The participant pushes a button for vote, the button being given to each participant of the meeting. The metadata of “decision” and “agree” or “decision” and “disagree” is attached.

(5) The light of the meeting room is turned off and the projector is powered on. The metadata of “presentation start” is attached. On the contrary, the light of the meeting room is turned on and the projector is powered off. The metadata of “presentation end” is attached.

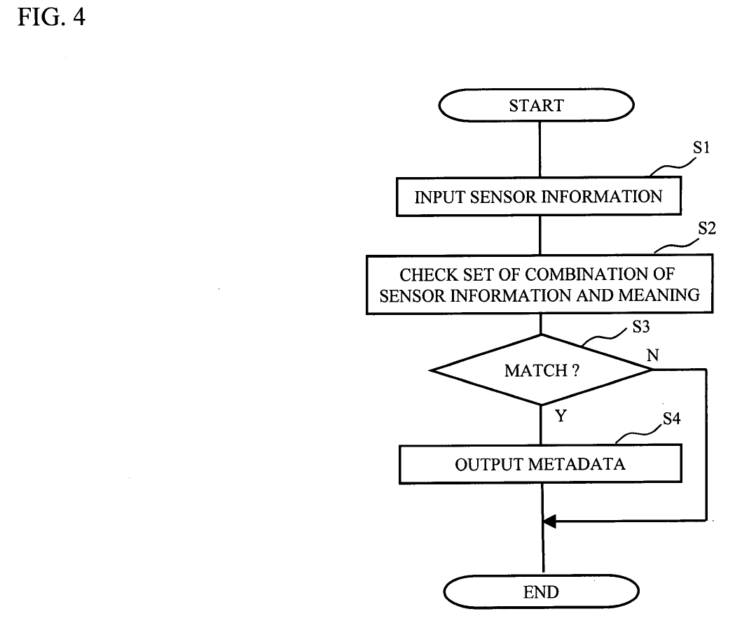

A description will be given of an attaching procedure of the metadata of the sensor combination determination unit 9. FIG. 4 is a flowchart showing a procedure of attaching the metadata of the sensor combination determination unit 9. In step S1, pieces of the sensor information are independently input into the sensor combination determination unit 9 from the ID management unit 5, and the sensor management units 61 through 6n, and the time offering unit 7. Instep S2, the sensor combination determination unit 9 checks the set of the combination of the sensor information and the meaning thereof stored in the database 8 for storing sets of the combinations of the sensor information and meanings thereof.

In step S3, if the input sensor information matches with the sensor information included in the set of the combination of the sensor information and the meaning thereof in the database 8 for storing sets of the combinations of the sensor information and meanings thereof in step S2, the sensor combination determination unit 9 sets the corresponding meaning as the metadata and outputs the metadata to the sensor information recording controller 11. If the input sensor information does not match with the sensor information included in the set of the combination of the sensor information and the meaning thereof in the database 8 for storing sets of the combinations of the sensor information and meanings thereof in step S2, the sensor combination determination unit 9 does nothing. The sensor information recording controller 11 receives as inputs, the output from the ID management unit 5 and the sensor management units 61 through 6n and the metadata from the sensor combination determination unit 9 so as to store in the sensor database 10.

It is thus possible to attach the metadata automatically to the moving image by judging the combination of the pieces of the sensor information, based on the sensor information of the sensors that sense the person, the object, and the movement of the person or the object, while the moving image is being taken. This makes it possible to search the moving image having a common feature of the person, the object, or the movement. Also, it is possible to attach the metadata to the moving image manually at a predetermined timing by a user's instruction.

### Second Embodiment

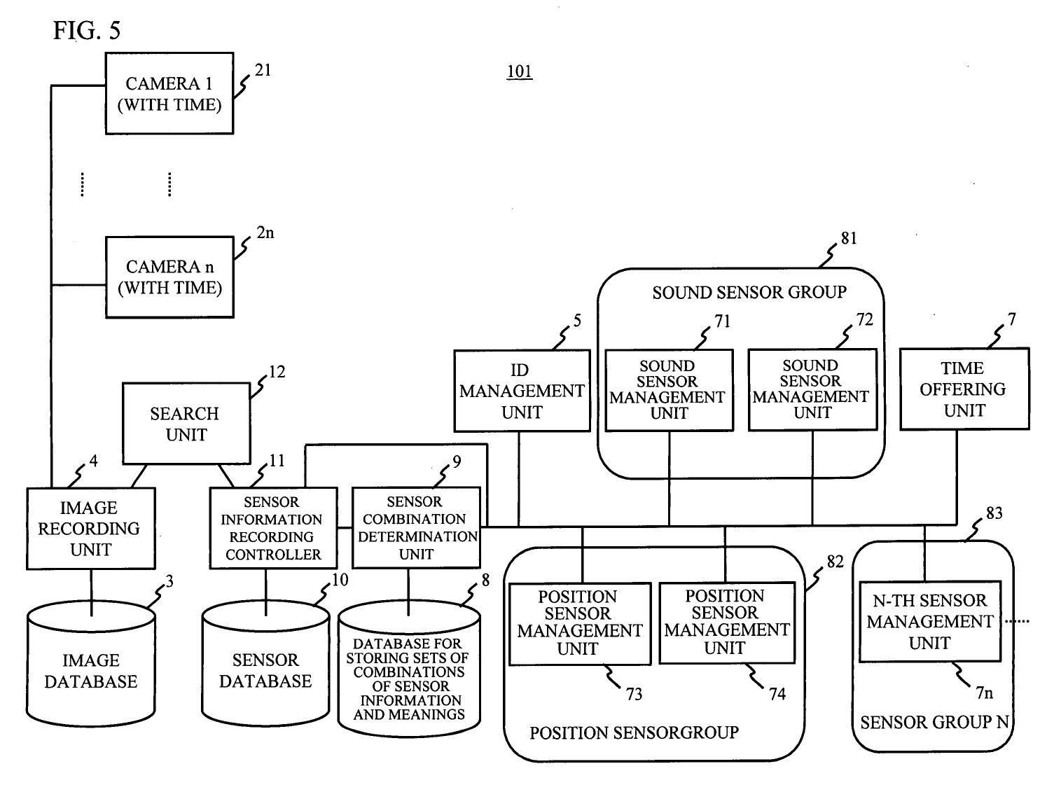

A description will now be given of a second embodiment of the present invention. FIG. 5 is a view showing a configuration of a moving image processing unit in accordance with a second embodiment of the present invention. Referring to FIG. 5, a moving image processing unit 101 includes multiple cameras 2n, the image database 3, the image recording unit 4, the ID management unit 5, the time offering unit 7, the database 8 for storing sets of the combinations of the sensor information and meanings thereof, the sensor combination determination unit 9, the sensor database 10, the sensor information recording controller 11, the search unit 12, sound sensor management units 71 and 72, position sensor management units 73 and 74, and nth sensor management units 7n. Hereinafter, in the second embodiment, the same components and configurations as those of the first embodiment have the same reference numerals.

The sound sensor management units 7l and 72 are, for example, respectively connected to microphones in the meeting room. Sound information of the microphone is managed as the sensor information. The sound sensor management units 71 and 72 form a sound sensor group 81. The position sensor management units 73 and 74 are connected to, for example, an ID detection unit installed in the meeting room, and manages the positional information of the person or the object existent in the meeting room, as the sensor information. The position sensor management units 73 and 74 form a position sensor group 82. Multiple nth sensor management units 7n form a sensor group 83. In this manner, the sensor groups are formed with the multiple sensor management units.

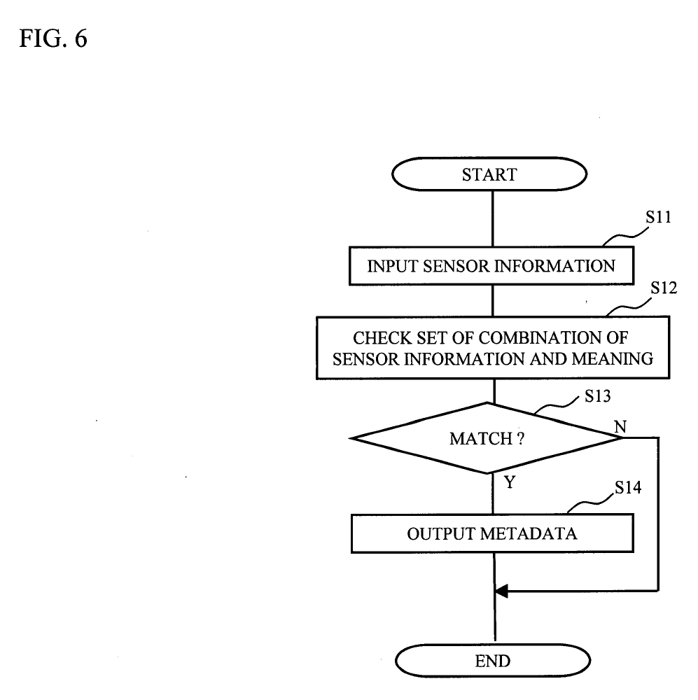

A description will be given of an attaching procedure of the metadata of the sensor combination determination unit 9. FIG. 6 is a flowchart describing another procedure of attaching the metadata of the sensor combination determination unit 9. In step S11, multiple sensors are divided into groups. The pieces of the sensor information are independently input into the sensor combination determination unit 9 from the ID management unit 5, the multiple sensor management units 71 through 7n, and the time offering unit 7. In step S12, sets of the combinations of the pieces of the sensor information from the sensor group and the meanings thereof are stored in the database 8 for storing sets of the combinations of the sensor information and meanings thereof shown in FIG. 5, in accordance with the second embodiment of the present invention. In step S13, the sensor combination determination unit 9 checks the set. In step S14, if the input sensor information matches with the sensor information from the sensor group in the database 8 for storing sets of the combinations of the sensor information and meanings thereof in step S13, the sensor combination determination unit 9 outputs the corresponding meaning to sensor information recording controller 11 as the metadata.

On the contrary, if the input sensor information does not match with the sensor information from the sensor group in the database 8 for storing sets of the combinations of the sensor information and meanings thereof in step S13, the sensor combination determination unit 9 does nothing. A flexible meaning method is also considered. If the input sensor information partially matches with the set of the combination of the pieces of the sensor information from the sensor group and the meanings thereof, a meaning is attached. The sensor information recording controller 11 receives as inputs, the outputs from the ID management unit 5 and the sensor management units 71 through 7n and the metadata from the sensor combination determination unit 9, and stores the inputs in the sensor database 10.

It is thus possible to associate the sensor data with the metadata readily by grouping the sensors in accordance with the second embodiment of the present invention. The database 8 for storing sets of the combinations of the sensor information and meanings thereof, shown in FIG. 5, is required to configure in advance, in accordance with the present invention. It is thus possible to facilitate the preparation. Specifically, arbitrary sensor can be connected in accordance with the present invention. However, the type of sensor may be limited (to the camera, microphone, the ID of the participant, the position sensors, the certain pen in the meeting) and groups of the sensor information may be formed based on the type of the sensor so as to describe the meaning by the group. If a new sensor is connected, only a decision may be made on what group the new sensor belongs to. It is possible to extract the metadata without reconfiguring the database 8 for storing sets of the combinations of the sensor information and meanings thereof, which is shown in FIG. 5.

It is thus possible to attach the metadata automatically to the moving image by judging the combination of the sensor information, based on the sensor information of the sensor that senses the person, the object, or the movement of the person or the object while the moving image is being taken. Also, it is possible to attach the metadata to the moving image manually at a predetermined timing by a user's instruction. This makes it possible to search the moving image having the common feature of the person, the object, or the movement.

It is possible to attach the real-time sensor information and time information of the person or the object while the person or the object is being taken and automatically or manually attach the metadata to the moving image. Thus, the metadata can be searched as a target. This can solve the problem in that it is difficult to add the annotation to the moving image or extract the metadata.

The moving image processing method can be realized with a CPU (Central Processing Unit), ROM (Read Only memory), and RAM (Random Access Memory). The program of the moving image processing method is installed from a portable memory device such as a hard disc unit, CD-ROM, DVD, or flexible disc, or is downloaded via a communication circuit. Each step is performed when the CPU executes the program.

The moving image processing unit may be installed in a mobile telephone or a camcorder, for example.

On the moving image processing unit in the above-mentioned aspect, the moving image processing unit may further include a memory in which the metadata is stored, the attachment unit referring to and a meaning of the combination of the sensor information being reflected in the metadata. It is thus possible to attach the metadata in which the meaning of the combination of different kinds of the sensor information to the metadata in advance.

On the moving image processing unit in the above-mentioned aspect, the moving image processing unit may further include a recording controller that stores the sensor information associated with the metadata in a given database. It is thus possible to provide the moving image based on the metadata attached to the moving image.

On the moving image processing unit in the above-mentioned aspect, the moving image processing unit may further include an image recording unit that records the moving image together with time information in a given database.

On the moving image processing unit in the above-mentioned aspect, the moving image processing unit may further include a search unit that searches the moving image based on an input search condition and the metadata.

On the moving image processing unit in the above-mentioned aspect, the moving image processing unit may further include an ID management unit that manages the person, the object, or the movement of the person or the object, with the use of an ID.

On the moving image processing unit in the above-mentioned aspect, the moving image processing unit may further include a time management unit that offers a detection time by a sensor.

On the moving image processing unit in the above-mentioned aspect, the sensor management unit may communicates with the attachment unit in a URL format. It is thus possible to realize a dynamic loose coupling different sensor devices in the URL format only.

On the moving image processing unit in the above-mentioned aspect, the sensor management unit may include at least one of a remark sensor management unit, a positional information management unit, and a handwritten input sensor management unit, the remark sensor management unit managing a remark sensor for detecting a remark, the positional information management unit managing a position sensor for detecting positional information, the handwritten input sensor management unit managing a handwritten input sensor.

On the moving image processing unit in the above-mentioned aspect, the attachment unit may attach the metadata of strong assertion based on the sensor information output from the sensor management unit, in a case where a drawing is created on a whiteboard with a given pen.

On the moving image processing unit in the above-mentioned aspect, the attachment unit may attach the metadata of remark based on the sensor information output from the sensor management unit, in a case where a button for making remarks is pushed or a switch of a microphone given to each participant of a meeting is turned on and a participant says something. The attachment unit may attach the metadata of either decision or approval based on the sensor information output from the sensor management unit, in a case where a majority of participants show hands. The attachment unit may attach the metadata of either decision and agree or decision and disagree based on the sensor information output from the sensor management unit, in a case a participant pushes a button for vote, the button being given to each participant of a meeting. The attachment unit may attach the metadata based on the sensor information output from the sensor management unit, according to powers of a room light and a projector. The attachment unit may attach the metadata judging a combination of sensor groups, based on the sensor information output from the sensor management unit.

On the moving image processing method in the above-mentioned aspect, the moving image processing method may further include attaching the metadata to the moving image, referring to a memory that stores the metadata in which a meaning of the combination of the sensor information is reflected.

On storage medium readable by a computer to execute a process of outputting images from an output unit on a computer in the above-mentioned aspect, the function of the storage medium may further include attaching the metadata to the moving image, referring to the metadata in which a meaning of the combination of the sensor information is reflected.

The storage memory may be a memory device such as a hard disc unit, CD-ROM, DVD, flexible disc, or the like.

Although a few embodiments of the present invention have been shown and described, it would be appreciated by those skilled in the art that changes may be made in these embodiments without departing from the principles and spirit of the invention, the scope of which is defined in the claims and their equivalents.

The entire disclosure of Japanese Patent Application No. 2004-305305 filed on Oct. 20, 2004 including specification, claims, drawings, and abstract is incorporated herein by reference in its entirety.

What is claimed is:

1. A moving image processing unit comprising:
a sensor management unit that manages sensors that detect at least one of a person, an object, a movement of the person or the object, and sound information as sensor information, while a moving image is being captured; and
an attachment unit that attaches metadata to the moving image, after checking a combination of the sensor information based on the sensor information outputted from the sensor management unit.

2. The moving image processing unit according to claim 1, further comprising:
a memory that stores the metadata, wherein the metadata is referred to by the attachment unit and a meaning of the combination of the sensor information is reflected in the metadata.

3. The moving image processing unit according to claim 1, further comprising:
a recording controller that records the sensor information associated with the metadata in a database.

4. The moving image processing unit according to claim 1, further comprising:
an image recording unit that records the moving image together with time information in a database.

5. The moving image processing unit according to claim 1, further comprising:
a search unit that searches the moving image based on a search condition and the metadata.

6. The moving image processing unit according to claim 1, further comprising:
an ID management unit that manages at least one of the person, the object, and the movement of the person and the object, by an ID.

7. The moving image processing unit according to claim 1, further comprising:
a time offering unit that offers a detection time by a sensor.

8. The moving image processing unit according to claim 1, wherein the sensor management unit communicates with the attachment unit in a URL format.

9. The moving image processing unit according to claim 1, wherein the sensor management unit includes at least one of a remark sensor management unit, a positional information management unit, and a handwritten input sensor management unit, the remark sensor management unit managing a remark sensor for detecting a remark, the positional information management unit managing a position sensor for detecting positional information, the handwritten input sensor management unit managing a handwritten input sensor.

10. The moving image processing unit according to claim 1, wherein the attachment unit attaches the metadata of strong assertion based on the sensor information outputted from the sensor management unit when a drawing is created on a whiteboard with a pen.

11. The moving image processing unit according to claim 1, wherein the attachment unit attaches the metadata of remark based on the sensor information outputted from the sensor management unit, when a button for making remarks is pushed or a switch of a microphone is turned on and/or a participant says something.

12. The moving image processing unit according to claim 1, wherein the attachment unit attaches the metadata of either decision or approval based on the sensor information outputted from the sensor management unit, when a majority of participants show of hands.

13. The moving image processing unit according to claim 1, wherein the attachment unit attaches the metadata of either decision and agree or decision and disagree based on the sensor information outputted from the sensor management unit, when a participant pushes a button for a vote.

14. The moving image processing unit according to claim 1, wherein the attachment unit attaches the metadata based on the sensor information outputted from the sensor management unit, according to electric power supply of a room light and/or a projector.

15. The moving image processing unit according to claim 1, wherein the attachment unit attaches the metadata judging a combination of sensor groups, based on the sensor information outputted from the sensor management unit.

16. A moving image processing method comprising:
detecting with a sensor at least one of a person, an object, or a movement of the person or the object while a moving image is being captured, as sensor information; and
attaching a metadata to the moving image, after checking a combination of the sensor information based on the sensor information outputted from the sensor.

17. The moving image processing method according to claim 16, further comprising:
attaching the metadata to the moving image, referring to a memory that stores the metadata in which a meaning of the combination of the sensor information is reflected.

18. A storage medium readable by a computer to execute a process of outputting images from an output unit on a computer, the function of the storage medium comprising:
acquiring sensor information of a sensor that detects at least one of a person, an object, or a movement of the person or the object while a moving image is being captured; and
attaching metadata to the moving image, after checking a combination of the sensor information based on the sensor information.

19. The storage medium according to claim 18, the function further comprising:
attaching the metadata to the moving image, referring to the metadata in which a meaning of the combination of the sensor information is reflected.

20. A moving image processing unit comprising:
a sensor management unit that manages a sensor that detects at least one of a person, an object, a movement of the person or the object, and sound information as sensor information, while a moving image is being captured; and
an attachment unit that attaches metadata to the moving image based on the sensor information outputted from the sensor management unit.
